(19) United States
(12) Patent Application Publication
(10) Pub. No.: US 2016/0085812 A1
(43) Pub. Date: Mar. 24, 2016

(54) METHOD OF MANAGING CONTENT IN ELECTRONIC APPARATUS AND ELECTRONIC APPARATUS CONTROLLED ACCORDING TO THE METHOD

(71) Applicant: SAMSUNG ELECTRONICS CO., LTD., Suwon-si (KR)

(72) Inventors: Seung-ran PARK, Hwaseong-si (KR); Myung-jin EOM, Seoul (KR)

(73) Assignee: SAMSUNG ELECTRONICS CO., LTD., Suwon-si (KR)

(21) Appl. No.: 14/669,807

(22) Filed: Mar. 26, 2015

(30) Foreign Application Priority Data
Sep. 24, 2014 (KR) 10-2014-0127680

(51) Int. Cl. G06F 17/30

(52) U.S. Cl. CPC G06F 17/30528; G06F 17/30268; G06F 17/30256; G06F 17/30477

(57) ABSTRACT

A method of managing content and an apparatus implementing the method are presented. The method of managing content includes obtaining content by an electronic apparatus; and executing an operation corresponding to a category related to the obtained content. The method of managing content enables an easy management of content obtained, by using the electronic apparatus, capable of obtaining content, which may conveniently manage content by automatic execution of an operation without direct executing an operation related to each of content by a user of the electronic apparatus.

### RELATED APPLICATION

This application claims the benefit of Korean Patent Application No. 10-2014-0127680, filed on Sep. 24, 2014, in the Korean Intellectual Property Office, the disclosure of which is incorporated herein in its entirety by reference.

### BACKGROUND

1. Field

One or more exemplary embodiments relate to a method of managing content obtained by using an electronic apparatus and the electronic apparatus.

2. Description of the Related Art

Due to improved performance and diversified function of a mobile device, a user of the mobile device may execute various programs on the mobile device. Moreover, since a user carries the mobile device for many hours, a situation often occurs where a user creates content regardless of location.

However, the content in the mobile device is mostly stored without being classified. Thus, a user must manually search the created content and execute a particular operation for the searched content which is not classified and it may be an inconvenience to a user.

### SUMMARY

One or more exemplary embodiments include a technical task to present a method of managing content in a manner of automatic executing an operation for the obtained content and an electronic apparatus, when the content is obtained in the electronic apparatus.

Additional aspects will be set forth in part in the description which follows and, in part, will be apparent from the description, or may be learned by practice of the presented exemplary embodiments.

According to one or more exemplary embodiments, a method of managing content includes obtaining content; and an executing operation corresponding to a category related to the obtained content.

According to one or more exemplary embodiments, the obtaining content further includes receiving an external input and determining the category corresponding to the content based on the external input.

According to one or more exemplary embodiments, the executing of an operation includes, searching for at least one selected from a character and an image in the obtained content, identifying at least one selected from the character and the image, and determining the category based on the identification.

According to one or more exemplary embodiments, the executing of the operation includes, if an available operation corresponding to the category is equal to at least two or more operations, receiving an external input, and executing at least one operation out of the available operations to the category, according to the external input.

According to one or more exemplary embodiments, the obtaining the content includes receiving signals from an input device corresponding to the executed application.

According to one or more exemplary embodiments, the obtaining content includes receiving location information obtained by the content.

According to one or more exemplary embodiments, the obtaining the content includes generating a new category corresponding to the content.

According to one or more exemplary embodiments, an apparatus for managing content includes an inputter configured to obtain content, and a controller configured to control an operation corresponding to a category related to the obtained content.

According to one or more exemplary embodiments, the controller is configured to determine the category related to the content, based on an input received by the inputter.

According to one or more exemplary embodiments, the controller is configured to search for at least one selected from a character and an image in the obtained content, identify at least one selected from the character and the image, and configured to determine the category based on the identification.

According to one or more exemplary embodiments, when two or more operations are related to a category, the controller is configured to execute at least one out of the two or more operations, based on the input received by the inputter.

According to one or more exemplary embodiments, the inputter is configured to receive a signal from an input apparatus coupled with an application of the electronic apparatus.

According to one or more exemplary embodiments, the inputter is configured to receive the location information of the electronic apparatus when obtaining the content.

According to one or more exemplary embodiments, the controller is configured to automatically execute the operation, which is one of a storing operation, a transmission operation, or a classification operation of the obtained content.

According to one or more exemplary embodiments, the controller is configured to generate a category corresponding to the obtained content.

According to one or more exemplary embodiments, a non-transitory computer-readable recording medium storing a program including instruction for managing a content including obtaining content and executing an operation corresponding to a category related to the obtained content.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 is a block diagram illustrating a configuration of an electronic apparatus, according to an exemplary embodiment;

FIG. 2 is a flowchart illustrating a method of managing content, according to an exemplary embodiment;

FIG. 3 is an example of the method illustrated in FIG. 2;

FIG. 4 illustrates another example of the method in FIG. 2;

FIG. 5 is a flowchart illustrating the method of managing content, according to an exemplary embodiment, which further includes determining a category related to the category corresponding to the content, based on an external input, prior to obtaining content;

FIG. 6 illustrates an example of the method in FIG. 5;

FIG. 7 is a flowchart illustrating content method of managing content according to an exemplary embodiment, which includes searching for at least one selected from a character and an image in the obtained content and automatically executing operations related to a category determined based on the search result;

FIG. 8 is a flowchart illustrating a method of determining a category when a character is searched for;

FIG. 9 illustrates an example of the method in FIG. 7 when only an image is searched for;

FIG. 10 illustrates an example of the method in FIG. 7 when both a character and an image are searched for;

FIG. 11 is a flowchart, according to an exemplary embodiment, in which two or more operations corresponding to a category related to the obtained content;

FIG. 12 illustrates an example of the method in FIG. 11;

FIG. 13 illustrates another example of the method in FIG. 11;

FIG. 14 is a block diagram illustrating the electronic apparatus receiving the location information content indicating where the content was obtained, according to an exemplary embodiment;

FIG. 15 illustrates an example according to exemplary embodiment in which the location information obtained via a global position system (GPS) is included in the content when the content is obtained;

FIG. 16 is a flowchart illustrating a method in which a user generates a new category as the category corresponding to content to be obtained, according to an exemplary embodiment;

FIG. 17 illustrates processes described in the flowchart of FIG. 16; and

FIG. 18 illustrates a process of changing a category name, an operation to be executed or a representative keyword of a category, when changing the category corresponding to the content, according to an exemplary embodiment.

### DETAILED DESCRIPTION

Reference will now be made in detail to exemplary embodiments, examples of which are illustrated in the accompanying drawings, wherein like reference numerals refer to like elements throughout. In this regard, the present exemplary embodiments may have different forms and should not be construed as being limited to the descriptions set forth herein. Accordingly, the exemplary embodiments are merely described below, by referring to the figures, to explain aspects of the present description. Expressions such as “at least one of,” when preceding a list of elements, modify the entire list of elements and do not modify the individual elements of the list.

When certain parts, throughout the present invention, “includes” certain component factor, this description, unless otherwise specified, does not mean to exclude other component factors but intends to further include other component factors. Also, a term such as “ . . . unit”, “module”, etc. described in the present invention means an element executing at least one function or an operation, and may be realized as hardware, software, or a combination of hardware and software.

For example, an electronic apparatus 100, may be a mobile phone, a smart phone, a laptop computer, a tablet PC, an electronic book terminal, a digital radio terminal, a personal digital assistant (PDA), a portable multimedia player (PMP), a navigation, an MP3 player, a digital camera, etc.; however, the electronic apparatus 100 is not limited hereto.

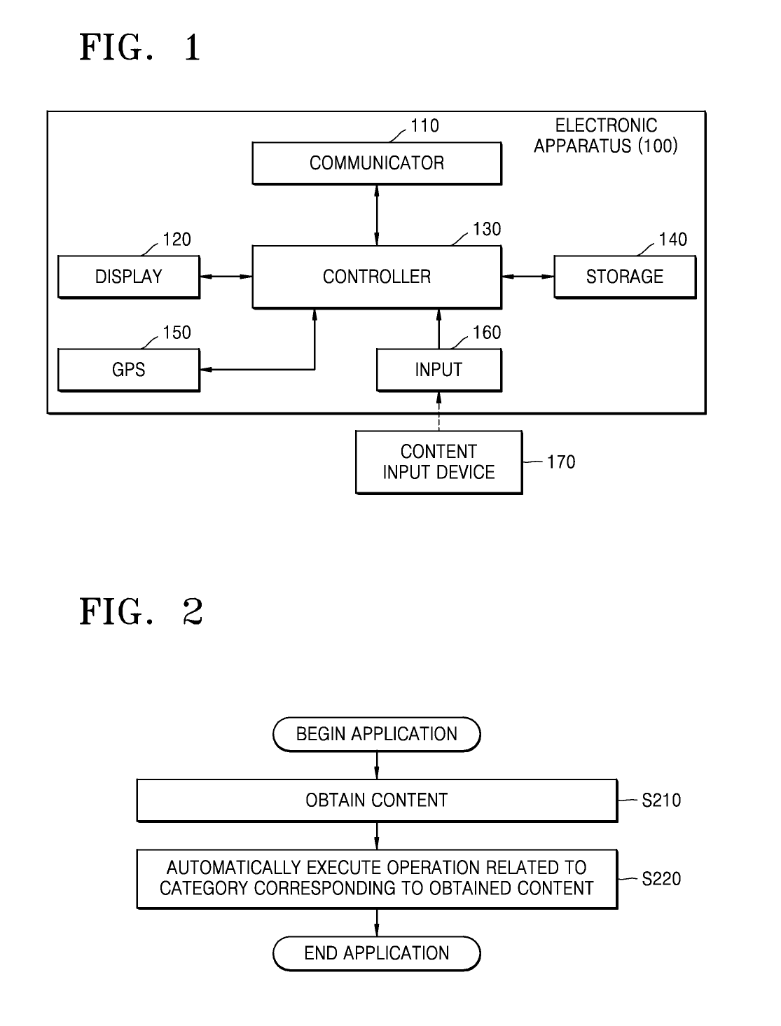

FIG. 1 is a block diagram illustrating a configuration of an apparatus for managing content according to one or more exemplary embodiments.

An electronic apparatus 100 may include a communication unit 110 (i.e., communicator), a display unit 120 (i.e., display), a control unit 130 (i.e., controller), a storage unit 140 (i.e., storage), a GPS module 150 (i.e., GPS), and an input unit 160 (i.e., inputter).

The communication unit 110 may be installed with RF interface-type devices for communication via, for example, Wi-Fi, Bluetooth, world interoperability for microwave access (Wimax), high speed downlink packet access (HSDPA), radio frequency identification (RFID), infrared data association (IrDA), and ZigBee.

The display unit 120 may include a liquid crystal display (LCD), and may display various indicator data, text messages, image data, etc. that are generated by the control unit 130. According to one exemplary embodiment, the display unit 120 displays operations that are automatically executed by the control unit 130.

The control unit 130 may determine a category which corresponds to content obtained through the input unit 160 and may control the electronic apparatus 100 such that the electronic apparatus 100 automatically executes operations related to the content.

The control unit 130 may determine a category corresponding to the content, based on the input received by the input unit 160.

The control unit 130 may search for a character, an image, or both, which are obtained through the input unit 160, and determine the category based on at least one selected from the character and the image searched for.

The control unit 130 may control GPS module 150 to get location information corresponding to the content when the content is obtained through the input unit 160.

The operations which are executed by the control unit 130 may be a storing operation, a transmission operation, or a classification operation of the obtained content.

The storage unit 140 may store data and content that are required for controlling operations of the control unit 130. The storage unit 140 may be realized by storage media (i.e., a non-volatile memory device such as cache, read only memory (ROM), programmable ROM (PROM) and electrically erasable programmable ROM (EPROM), volatile memory such as random access memory (RAM)) or a hard disc drive; however, the storage unit 140 is not limited thereto.

The GPS module 150 may provide a user of the electronic apparatus 100 with information indicating the present location of the electronic apparatus 100, based on GPS signals the GPS module 150 receives from a GPS satellite (not shown).

The input unit 160 may be used in obtaining content, generating the category, and modifying names, operations to be executed and a representative keyword, etc. of the category corresponding to the content. The input unit 160 may include a touch button, a touch screen, etc.; however, the input unit 160 is not limited thereto.

According to an exemplary embodiment, operations related to a category corresponding to content may be automatically executed for the content which is prepared using a content input device 170 on external apparatuses and stored in the storage unit 140 after being received by the electronic apparatus 100 through the transmission unit 110, in addition to a method where the electronic apparatus 100 obtains content directly prepared onto the electronic apparatus 100 using a content input device 170.

According to an exemplary embodiment, the content input device 170 is a content tool used for inputting a character or image to be searched. The input device 170 is not limited to electricity-flowing conductive materials. For example, the input device 170 may be an apparatus or a user's finger. Also, the input device 170 may be a non-conductive, arbitrary tool used for inputting data.

According to an exemplary embodiment, the input device 170 may be coupled with an application of the electronic apparatus 100. For example, when the electronic apparatus 100 receives predetermined signals from the content input device 170, a specific application of the electronic apparatus 100 may be executed in correspondence with the predetermined signals. Detailed descriptions are to be explained below.

FIG. 2 is a flowchart illustrating a method of managing content according to an exemplary embodiment.

In operation S210, the electronic apparatus 100 obtains created content created by using the input device 170.

In operation S220, the electronic apparatus 100 automatically executes operations related to the category corresponding to the obtained content.

According to exemplary embodiments, in relation to operation S220, a category corresponding to the obtained content is determined based on a predetermined condition. For example, the category may correspond to content relating to the number of times a keyword belonging to the category matches a word included in the obtained content. The predetermined condition may be modified by a user. For example, one or more keywords may be added to the category or one or more existing keywords may be included in the category.

Also according to the exemplary embodiments, the execution of operations corresponding to a category refers to an automatic execution of the operations related to the category corresponding to the obtained content. The operations corresponding to the category may be modified by a user, and may be designated during the generation of a category by a user. Detailed descriptions according to exemplary embodiments are to be explained below.

Operations related to the category may include storing the obtained content onto a storage medium of the electronic apparatus 100, sending the obtained content to another device, classifying the obtained content according to predetermined conditions, or coupling with other applications. Examples of other applications may include applications related to contact information, telephone numbers, calendar, things-to-do, photo album, alarm, e-mail, text message, SNS, calculator applications, etc.; however, the application are not limited hereto.

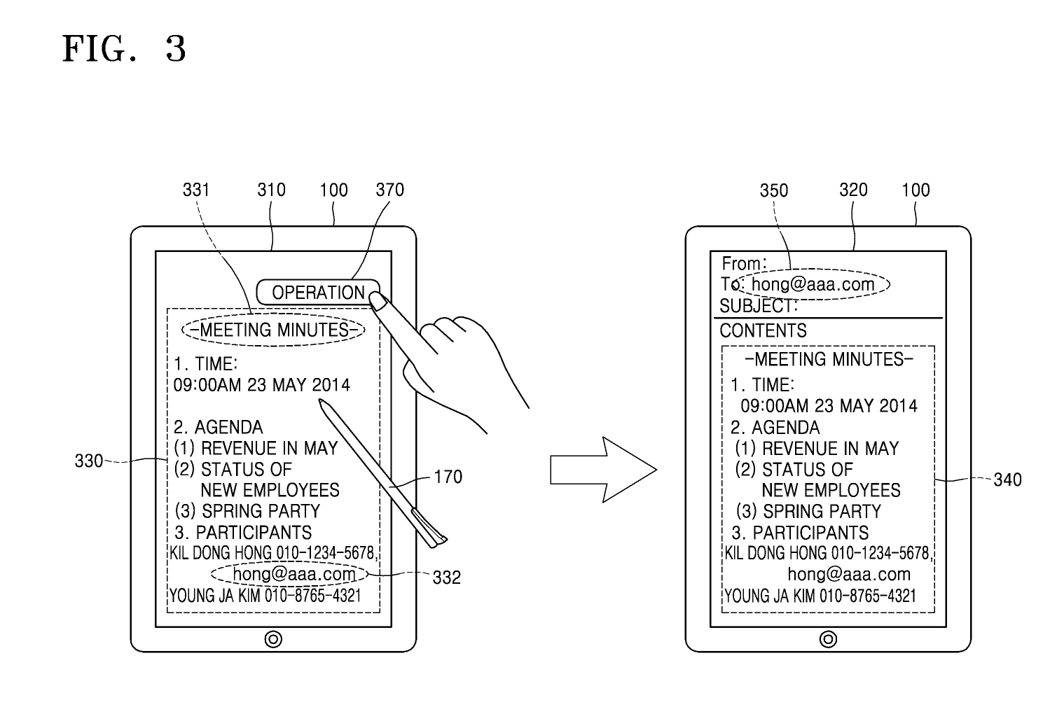

FIG. 3 illustrates the method of managing content according to an exemplary embodiment. According to the exemplary embodiments, it is assumed that the category corresponding to the content is generated as a “meeting minutes” and an operation related to the category is generated as “sending e-mail”. The process of determining whether the category corresponding to the content is the “meeting minutes” may be a process of determining whether the electronic apparatus 100 obtains content based on the external input, or a process of searching for a word in the obtained content and determining whether the searched word matches a representative keyword of the “meeting minutes” category. For example, the representative keyword may include meeting minutes, weekly meeting, monthly meeting, etc.

In the exemplary embodiment illustrated in FIG. 3, a word 331, such as, “meeting minutes”, may be searched for among words in an obtained content 330. The category corresponding to the obtained content 330 is determined as “meeting minutes” by comparing the obtained content 330 with a representative keyword of the category, according to an exemplary embodiment. After obtaining content through a content input display 310, operations related to a category corresponding to the obtained content 330 are executed by pressing a button 370. If the operations corresponding to the category include “sending e-mail” operation, the obtained content 330 is sent via e-mail, and operations related to the category are executed. According to an exemplary embodiment, if specific words are included in the obtained content 330 and the specific words include an e-mail address, for example, @.com, then an e-mail application may be executed and an e-mail may be sent to the corresponding e-mail address. Referring to FIG. 3, an e-mail address of hong@aaa.com 332 may be searched for and the “meeting minutes” is accordingly determined as the category corresponding to the obtained content 330. The obtained content 330 may be included in an e-mail as an image corresponding to the obtained content 330 or text data extracted through optical character recognition (OCR) from the obtained content 330; however, the obtained content 330 is not limited thereto.

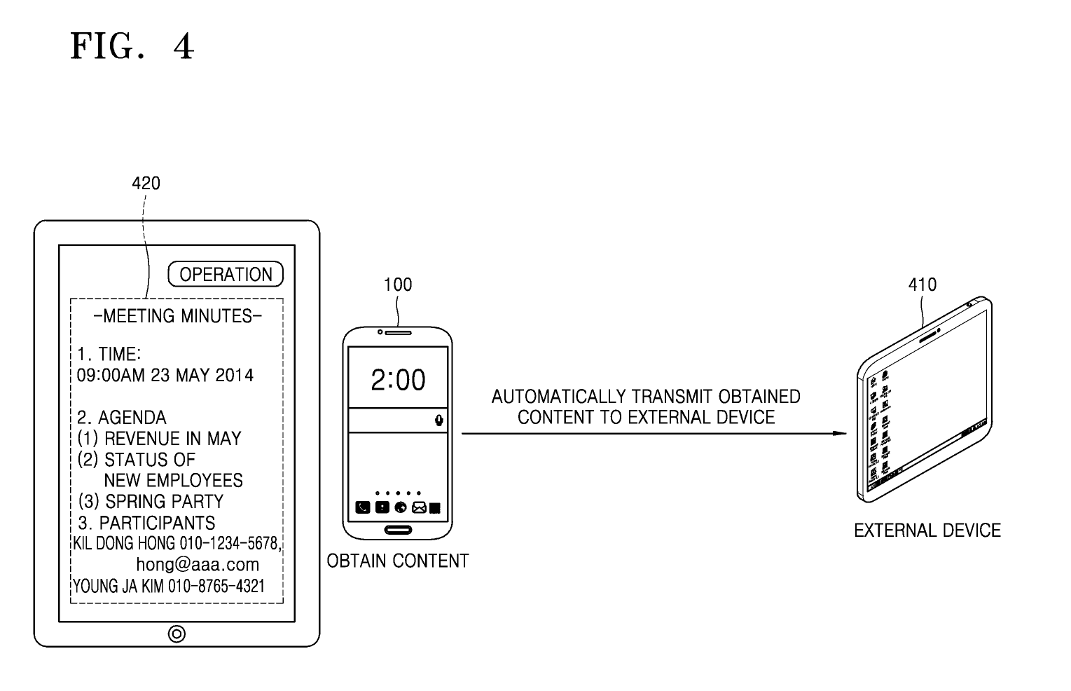

FIG. 4 illustrates a method of managing content according to an exemplary embodiment. Automatically executing operations related to the category corresponding to the content 420 obtained in the electronic apparatus 100 and automatically storing the obtained content 420 in an outside device 410 may be possible. The outside device 410 and the electronic apparatus 100 may be connected through a wire or wireless network, and the wireless network may be Wi-Fi, Bluetooth, world interoperability for microwave access (Wimax), high speed downlink packet (HSDP), radio frequency identification (RFID), infrared data association (IrDA), ZigBee, etc.; however, the exemplary embodiments are not limited hereto. Through these operations, a user of the electronic apparatus 100 may automatically back up the obtained content onto the outside device 410 without the inconvenience of having to individually select the obtained content for a backup after storing the obtained content onto the electronic apparatus 100. In addition, a user of the electronic apparatus 100 may not need to go through a process of individually searching for and transmitting content in the electronic apparatus 100 when the obtained content needs to be identified from the outside device 410.

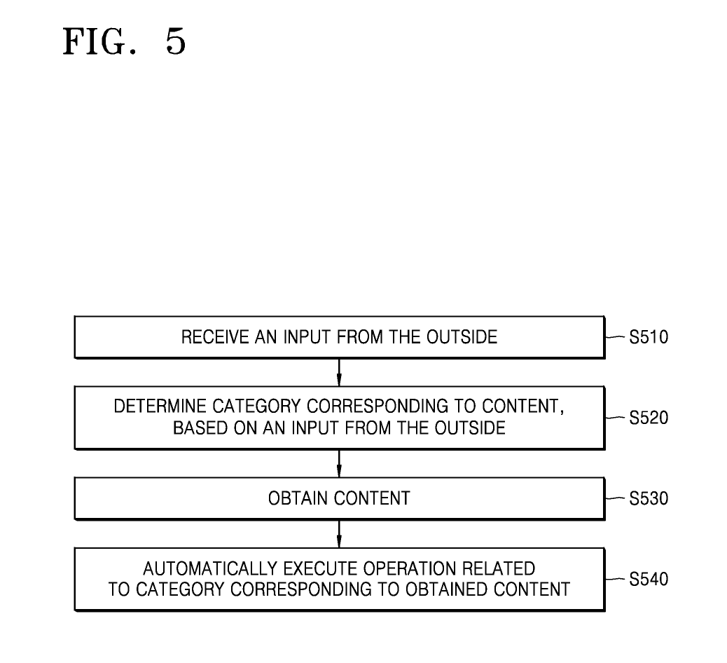

FIG. 5 is a flowchart illustrating the method of managing content, according to an exemplary embodiment, which further includes determining a category corresponding to the content, based on the external input, prior to obtaining the content.

In operation S510, the electronic apparatus 100 receives the external input.

In operation S520, the category corresponding to the content is determined, based on the external input.

In operation S530, the content is obtained.

Operations related to the category determined as corresponding to the obtained content are automatically executed in operation S540. Operations related to the category may include storing the obtained content in a storage medium of the electronic apparatus 100, transmitting the content to the outside, storing the content after classification according to a predetermined basis, coupling with other applications, etc. Examples of other applications may include applications related to a contact, a telephone, a calendar, things-to-do, a photo album, an alarm, an e-mail, a text message, an SNS, a calculator, etc.; however, the exemplary embodiments are not limited hereto.

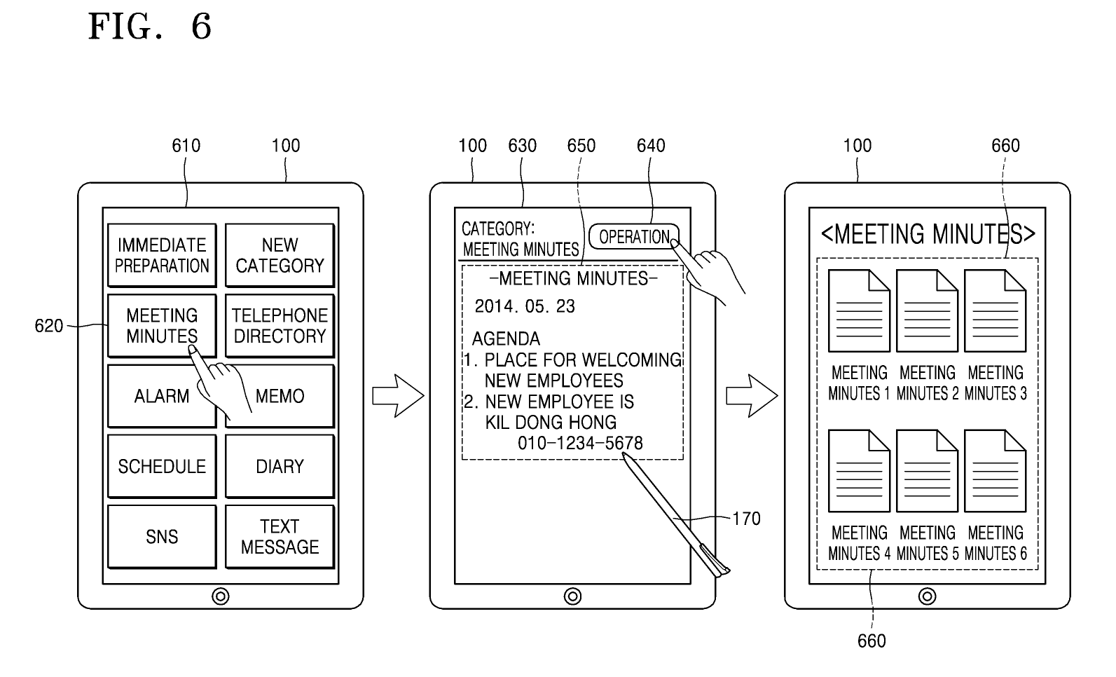

FIG. 6 illustrates the method of managing content described in FIG. 5, according to an exemplary embodiment. When the electronic apparatus 100 receives the external input, the category is determined, based on the external input. For example, when an input is received and the category is determined to be one of predetermined categories arranged on a display 610 displaying categories, the electronic apparatus 100 determines a meeting minutes category 620, based on the received input, as the category corresponding to content to be obtained in the future. After the content is prepared on a content input screen 630, a button 640 for an operation for a prepared content 650 is touched. Then, a predetermined operation, for example, an operation of storing into a meeting minutes folder 660, is automatically executed as an operation related to the determined meeting minutes category 620.

According to an exemplary embodiment, the method of managing content further including determining the category based on the external input may not be the only method that the electronic apparatus 100 performs. The external input may determine the category prior to obtaining the content and may further include determining the category based on the external input. In addition, a method may be performed where the electronic apparatus 100 receives the external input for determining the category after obtaining content and further includes determining the category based on the received external input.

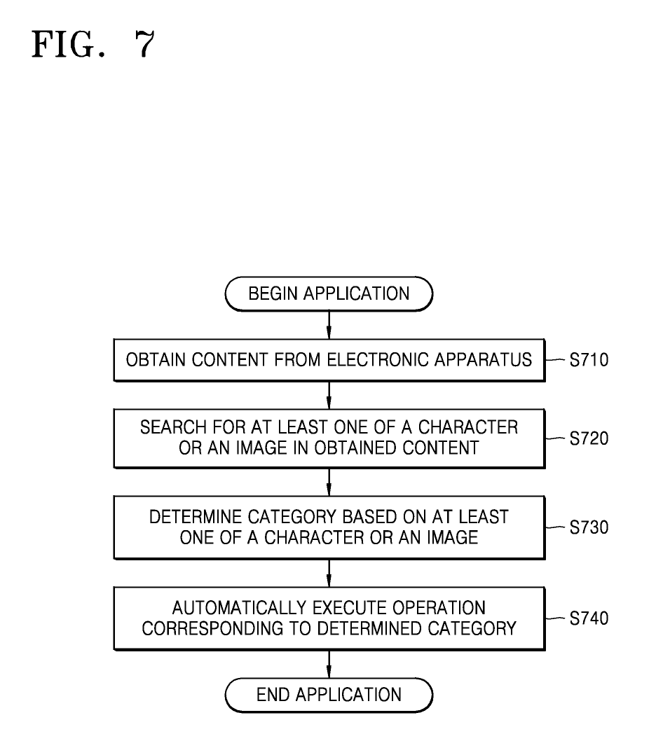

FIG. 7 is a flowchart illustrating a method, the method relating to the managing of content according to an exemplary embodiment. The method searches for at least one selected from a character and an image in the obtained content and automatically executes an operation related to a category determined by the search result.

In operation S710, the electronic apparatus 100 obtains the prepared content using the content input device 170.

In operation S720, the electronic apparatus 100 searches for at least one selected from a character and an image in the obtained content. Typed characters may be included in the obtained content using a keyboard. When the obtained content is prepared not by keyboard typing but by hand writing characters, text using a touch screen, etc., the obtained content is a type of image. Thus, operation S720 may include transforming the obtained content to character data and may use optical character reader (OCR) in a process of text data transformation; however, the scope of the exemplary embodiments are not limited thereto.

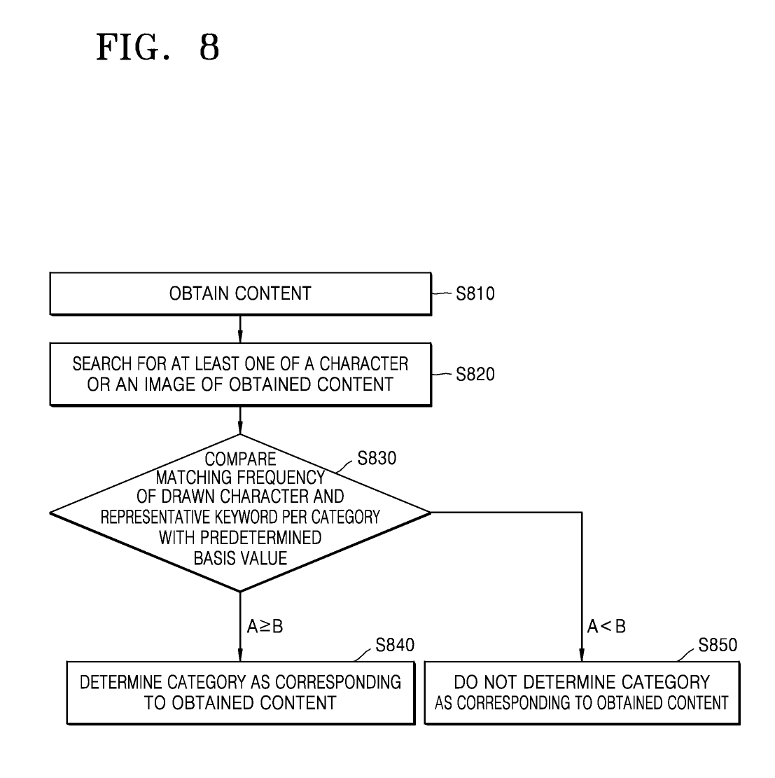

In operation S730, the electronic apparatus 100 determines the category based on at least one selected from a character and an image searched for in operation S720. For example, the category may be determined by comparing the result of transforming either characters typed by a keyboard or images prepared by hand, which are searched for in operation S720, with the representative keyword of the predetermined category. This comparison process and associated details are further described in FIG. 8.

In operation S740, an operation corresponding to the category determined in operation S730 is automatically executed. An operation may include storing the obtained content to the storage unit 140 of the electronic apparatus 100, transmitting the obtained content to the outside, storing the obtained content after classification with a predetermined basis, or coupling with other applications, i.e., applications related to contacts, telephones, calendars, things-to-do, photo albums, alarms, e-mails, text messages, SNS, calculators, etc.; however, the scope of the operation is not limited hereto.

FIG. 8 illustrates in detail a process of comparing the obtained content with a representative keyword in operation S730 in FIG. 7, according to an exemplary embodiment.

In operation S810, the electronic apparatus 100 obtains the content prepared using the content input device 170.

In operation S820, the electronic apparatus 100 searches for at least one selected from a character and an image in the obtained content. In the obtained content, typed characters using a keyboard may be included. Since the content obtained by preparing characters or text by hand using the touch screen does not include the content obtained by typing using a keyboard but a kind of images, operation S820 may include an operation for transforming the obtained content to text data, and may use optical character reader (OCR) in a text data transformation process; however, the scope of the operation is not limited thereto.

In operation S830, after at least one selected from a character and an image in operation S820 is searched for, in relation to the content obtained in operation S810, characters drawn out of the search result and a representative keyword set in accordance with the category may be compared.

In operation S840, when the matching frequency A of drawn characters and a representative keyword is higher than a predetermined arbitrary basis value B, the category is determined to correspond to the content obtained in operation S810.

In operation S850, when the matching frequency A of drawn characters and a representative keyword is lower than a predetermined arbitrary basis value B, the category is not determined as corresponding to the obtained content. If the number of categories determined to correspond to the content is equal to one, an operation related to the category is automatically executed. However, if the number of categories determined as corresponding to the content is greater than one (i.e., a plurality), an additional operation may be included for selecting one out of a plurality of categories based on the received external input. This process for selecting one of the plurality of categories is the same as described in FIG. 6.

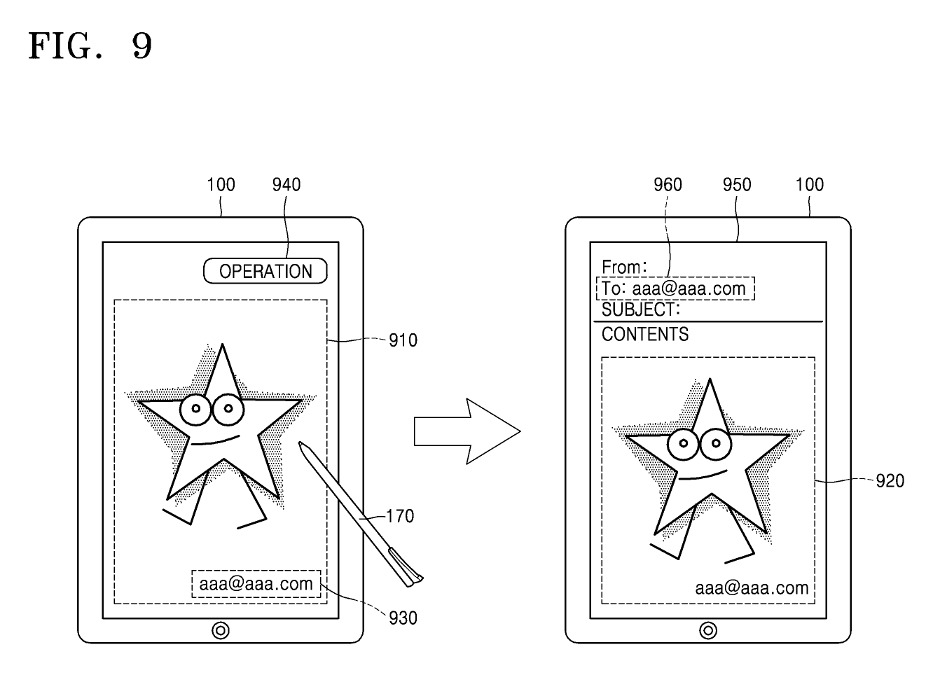

FIG. 9 illustrates the method of managing content, for a case of an automatic execution of an operation when the content including a specific word or character is obtained in the electronic apparatus 100, according to an exemplary embodiment. When the content, including a character (i.e., the content with transformed text data exists as typed content using a keyboard or hand-prepared content using the content input device 170, is obtained in the electronic apparatus 100, an operation is automatically executed, based on the search result of characters in the obtained content at the time of receiving an input for operation 940.

In this case, based on the e-mail address which is a searched character 930, the content is transmitted to an e-mail application and the content 910 obtained on an e-mail preparation screen 950 is included in an e-mail content 920, and the e-mail address which is the searched character 930 is automatically input to an e-mail receiver space 960.

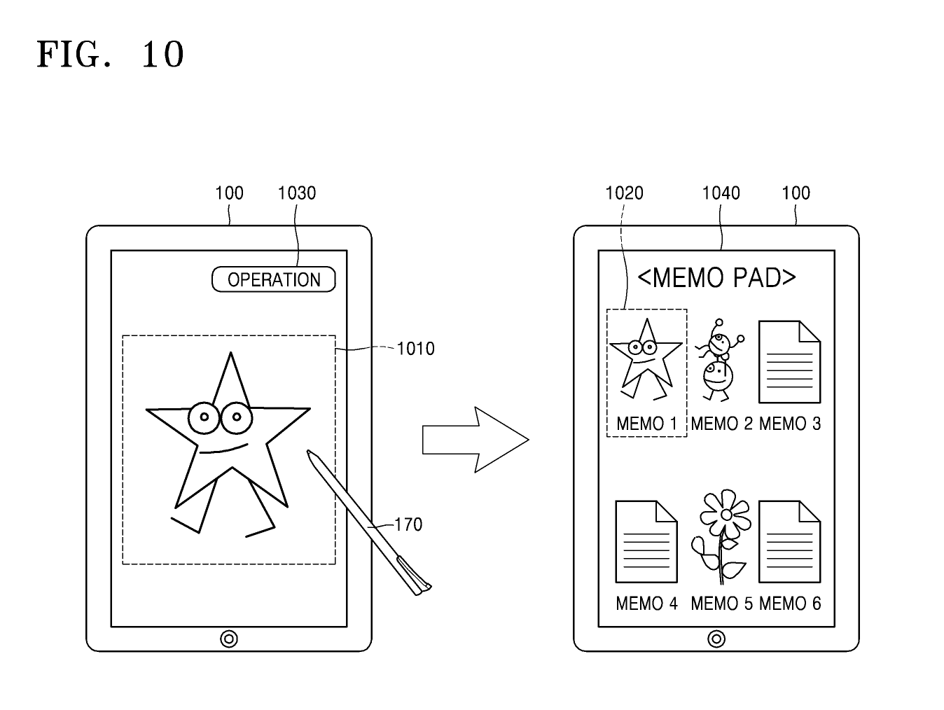

FIG. 10 illustrates the method of managing content, for a case of automatic execution of an operation when the content not including a specific character is obtained in the electronic apparatus 100, according to an exemplary embodiment. When the content, which does not include a specific character 1010 (i.e., when the content typed using a keyboard does not exist or when text data matching a keyword set in accordance with the category in the content, which is transformed to text data after the content is hand-prepared using the content input device 170, does not exist) is obtained in the electronic apparatus 100, an operation is automatically executed. In this case, since the content obtained 1010 in the electronic apparatus 100 does not include a character, when an input 1030 for executing an operation is received, an operation of storing in memo pad application is executed. Depending on the execution result of the operation, the obtained content 1010 on the memo pad application screen 1040 is displayed as a data 1020 stored in the memo pad application. The operation is not limited to the above-mentioned exemplary embodiment and may be re-set by the user to execute other operations by a user.

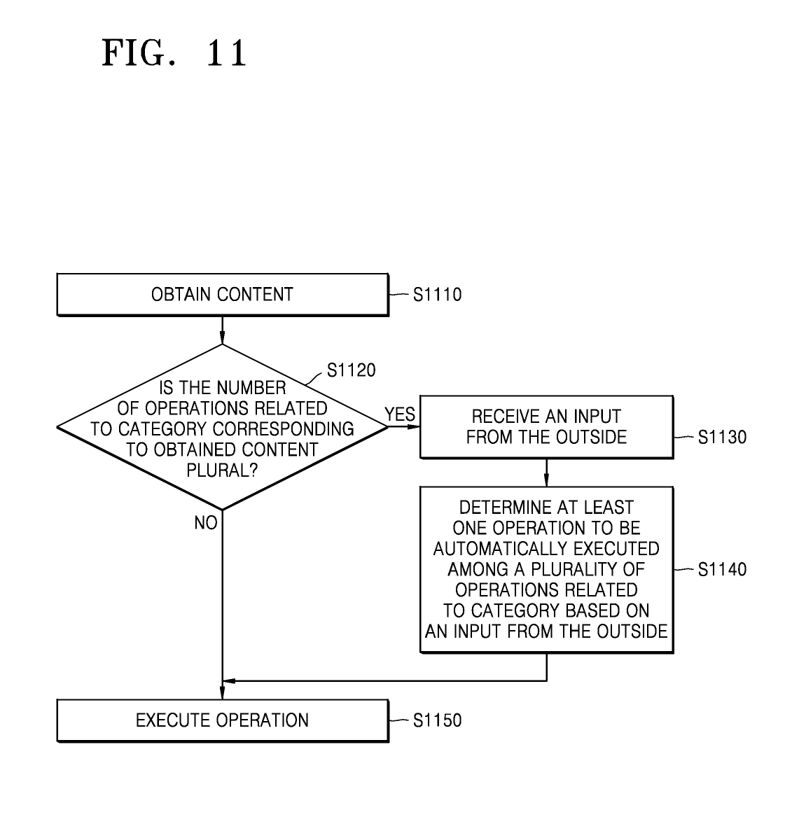

FIG. 11 is a flowchart illustrating a method of managing content, according to an exemplary embodiment. The method of managing content relates to managing the number of operations related to a category corresponding to a plurality obtained content. At least one operation may include an operation related to each category for classification of the content obtained in the electronic apparatus 100. When the number of operations is equal to one, an operation related to the content is automatically executed; however, when the number of operations is greater than one, it may be determined that at least one operation is executed, based on the received external input.

In operation S1110, the electronic apparatus 100 obtains the content prepared using the content input device 170.

In operation S1120, a determination of the number of operations related to the category is verified. If the number of operations related to the category is one, an operation is automatically executed in operation S1150.

In operation S1130, if the number of operations related to the category is greater than one, the input may be received to determine automatic execution of operations.

In operation S1140, at least one operation to be automatically executed may be determined among operations related to a plurality of categories based on the input received in operation S1130.

In operation S1150, at least one operation from the determined operations determined to be executed in operation S1140 may be automatically executed.

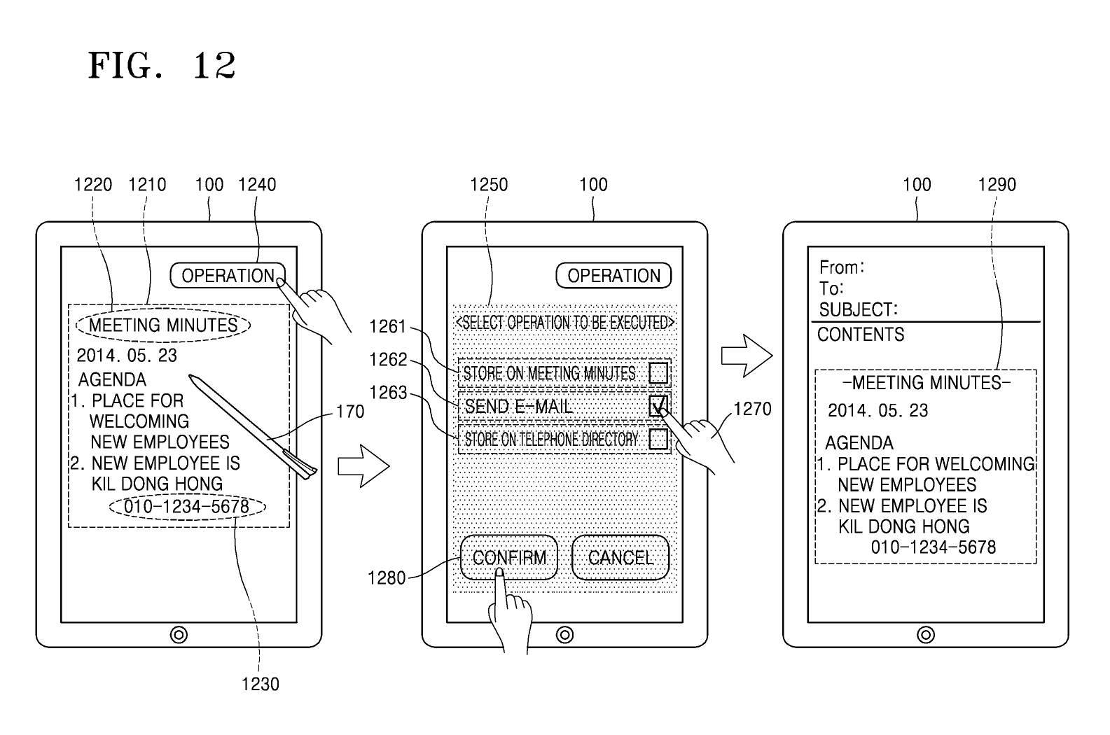

FIG. 12 is a flowchart illustrating a method of managing content, according to an exemplary embodiment. The method of managing content relates to the number of operations related to a category corresponding to the plurality of obtained content is plural. After the content is obtained in the electronic apparatus 100, an input 1240 for an operation is received, at which point at least one selected from a character and an image in the content 1210 obtained in the electronic apparatus 100 is searched for.

As a result of searching for at least one selected from a character and an image in the content 1210 obtained in the electronic apparatus 100, a meeting minutes category having a keyword of meeting minutes 1220, and a telephone directory category having a keyword of telephone number type 1230, for example, _{———}-_{———}-_{———}, may be determined as corresponding to the obtained content 1210.

If an operation of storing in the meeting minutes 1261 and sending an e-mail 1262 exists as an operation related to a category of meeting minutes, and an operation of storing in the telephone directory 1263 exists as an operation related to a category of telephone directory, operations related to a category corresponding to the obtained content 1261 through 1263 are displayed on the display unit 120 of the electronic apparatus 100. By confirmation 1280, the electronic apparatus 100 may determine at least one operation to execute among the 1261 through 1263, based on an input received from the outside 1270.

According to an exemplary embodiment, among storing on the meeting minutes 1261, sending an e-mail 1262 and storing on the telephone directory 1263, an operation of sending an e-mail 1262 is determined as an operation to be executed, based on the received external input. As a result, the obtained content executes an operation of including the content of an e-mail 1290 in the electronic apparatus 100, after executing an e-mail application.

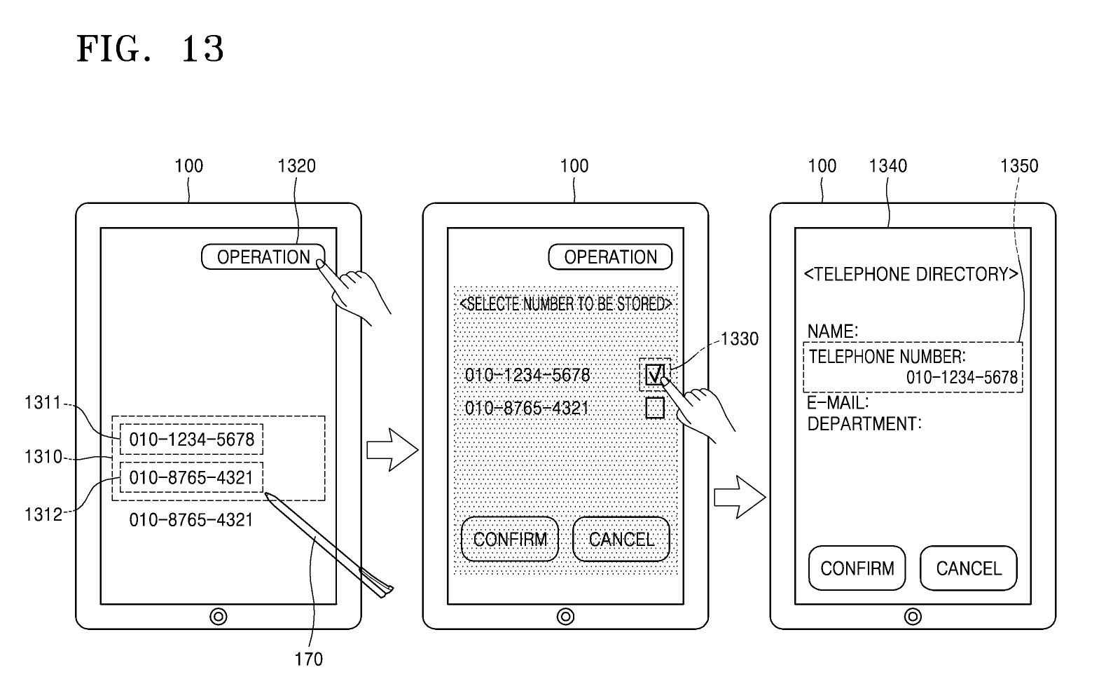

FIG. 13 illustrates a method of managing content according to an exemplary embodiment including a determining a part of the obtained content for executing each operation, when executing a plurality of operations for a part of the content obtained in the electronic apparatus 100. According to an exemplary embodiment, the electronic apparatus 100 is set up for automatic execution of an operation to store the content including telephone number type 1230 in the telephone directory.

After a content 1310 corresponding to a telephone number is obtained in the electronic apparatus 100, and when, as a search result for a character in the obtained content 1310, includes two subjects 1311, 1312 corresponding to a telephone number is recognized, an external input 1330 may be received and, based on the received external input, at least one selected from the subjects 1311 and 1312 may be determined as a subject to execute an operation of storing in the telephone directory.

According to an exemplary embodiment, the telephone directory application is executed and the telephone number 1311 is automatically written in a telephone number space 1350 in order to store the telephone number 1311 in the telephone directory.

As the method of managing content according to an exemplary embodiment, the electronic apparatus 100 includes obtaining content prepared using the content input device 170 and automatic executing operations related to a category corresponding to the obtained content. The obtaining content obtains content through an application of the electronic apparatus 100 related to the content input device 170.

The obtaining content according to an exemplary embodiment may include receiving a specific signal from the content input device 170, and may further include executing an application of the electronic apparatus 100 related to the content input device 170, based on the specific signal. The content input device 170 may be connected to the electronic apparatus 100 through a wire or wireless, and wireless communication network may be Wi-Fi, Bluetooth, radio frequency identification (RFID), infrared data association (IrDA), ZigBee, etc.; however, the scope of the exemplary embodiments are not limited hereto.

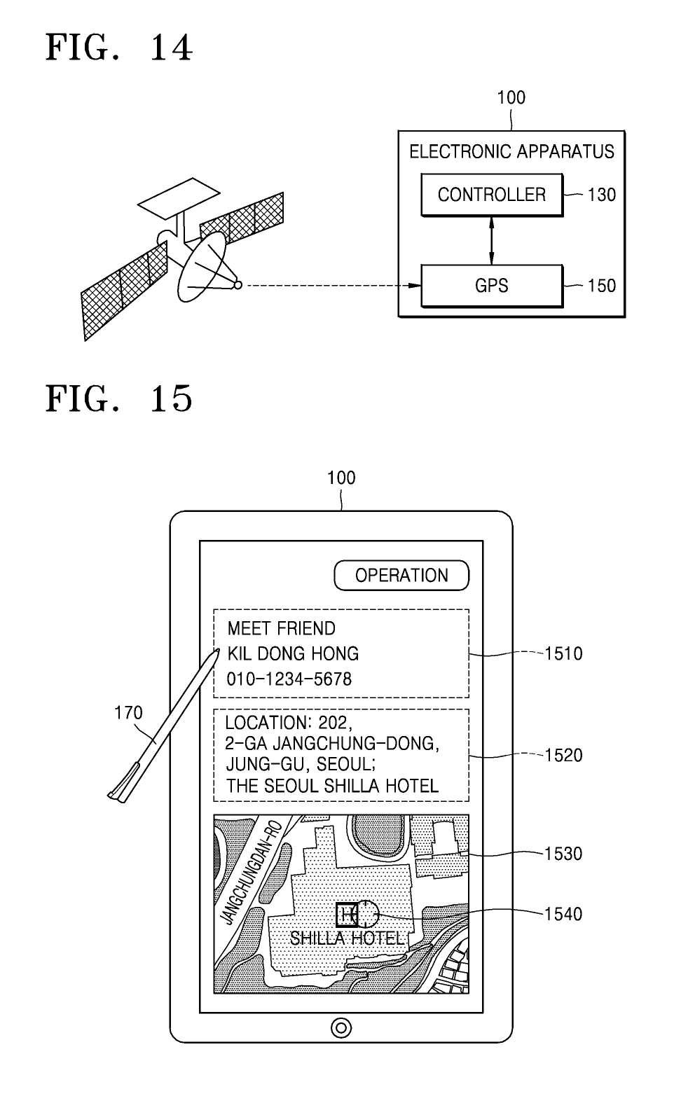

FIG. 14 illustrates, as the method of managing content according to an exemplary embodiment, that the electronic apparatus 100 may be configured to include obtaining content. The obtaining content may include automatically executing an operation related to a category corresponding to the obtained content, and the obtaining content may further include obtaining location information on where the content is obtained. For example, the control unit 130 of the electronic apparatus 100 may receive location information of the electronic apparatus 100 at the time of obtaining content using the GPS module 150 connected with the electronic apparatus 100, and provide a display indicating a text showing a location information or a location on a map.

FIG. 15 illustrates that the location information is included in the content when the content is received using the location information of the GPS. The electronic apparatus 100 may, at the time when the content is prepared, receive the present location information, and provide a text and a map for the presently received location information on a screen where the content is prepared. For example, if the content is presently prepared at Seoul Shilla Hotel, the electronic apparatus 100 may include the location information of Seoul Shilla Hotel in the content data to be stored, and may display 202, 2-ga Jangchung-dong, Jung-gu, Seoul; Seoul Shilla Hotel 1520, which is the text information of a location corresponding to Seoul Shilla Hotel on the screen where the content is prepared. Also, the electronic apparatus 100 may display content including a mark 1540, indicating the present location, on an application screen 1530 which is related to a map and coupled with an application where the content is prepared.

According to an exemplary embodiment, in the obtaining content, information for present location may be intuitively indicated, and the content obtained, based on location information included in the obtained content, may be classified corresponding to the obtaining area.

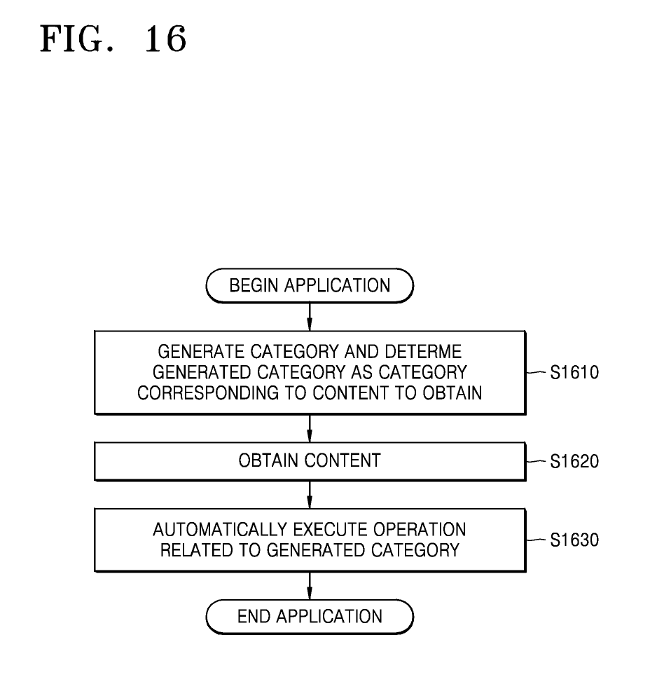

The method of managing content, according to an exemplary embodiment, may include obtaining content and automatically executing an operation related to a category corresponding to the obtained content, and the category corresponding to the obtained content may be generated in the electronic apparatus 100. Detailed description of this method discussed herein, as illustrated in FIG. 16.

FIG. 16 is a flowchart illustrating the method including generating a category and determining the category related to content which is obtained after generating the category content, according to an exemplary embodiment.

In operation S1610, a category is generated and the generated category is determined to be the category corresponding to the content to obtain.

In operation S1620, the electronic apparatus 100 obtains content.

In operation S1630, the electronic apparatus 100 automatically executes an operation related to a category determined in operation S1610 as the category corresponding to the content obtained in operation S1620.

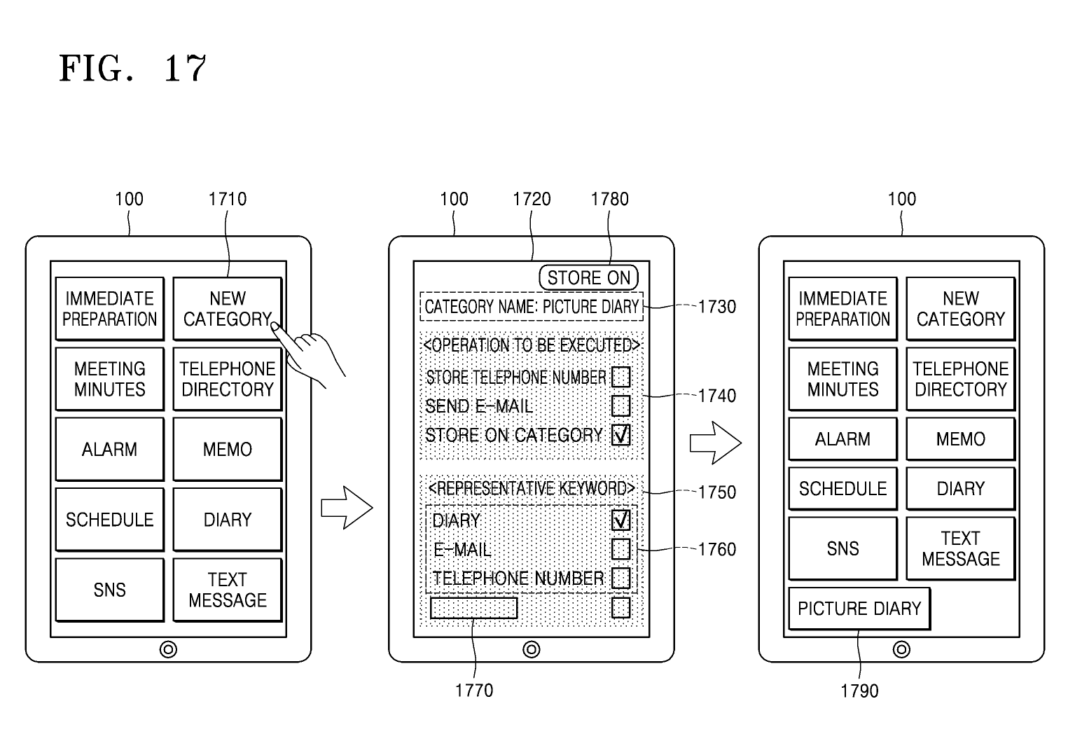

FIG. 17 illustrates processes illustrated in the flowchart of FIG. 16. The electronic apparatus 100 receives the external input and displays a category generation screen 1720 by touching a button 1710 for generating a category based on the external input. On the category generation screen 1720, a set-up of a name of a category to be generated based on the external input 1730, a set-up of category-related operation 1740, and a set-up of category-related keyword 1750 may be executed.

When a keyword of a category to be generated is set up, the electronic apparatus 100 may display a keyword 1760, according to an existing, different category, and may set up a new keyword in a category to be generated by writing a new keyword in a writing new keyword pace 1770. When an input for generating a category 1780 is received, the electronic apparatus 100 generates a new category properly set up for a user preference.

A generated category 1790 may be displayed on the display unit 120 in a process that the external input is received prior to obtaining content in the electronic apparatus 100 and the generated category 1790 is determined as the category corresponding to the content, based on the received external input.

The method of managing content, according to an exemplary embodiment, includes obtaining content and automatically executing an operation related to a category corresponding to the obtained content, such that the electronic apparatus 100 may change a keyword and an operation to execute, which are set up in an already-existing category, based on the external input.

For example, the electronic apparatus 100 may receive the external input for changing a name of a specific category among existing categories, a representative keyword of the category and an operation to be executed, and determine a category to be changed, based on the external input, and display a screen for changes.

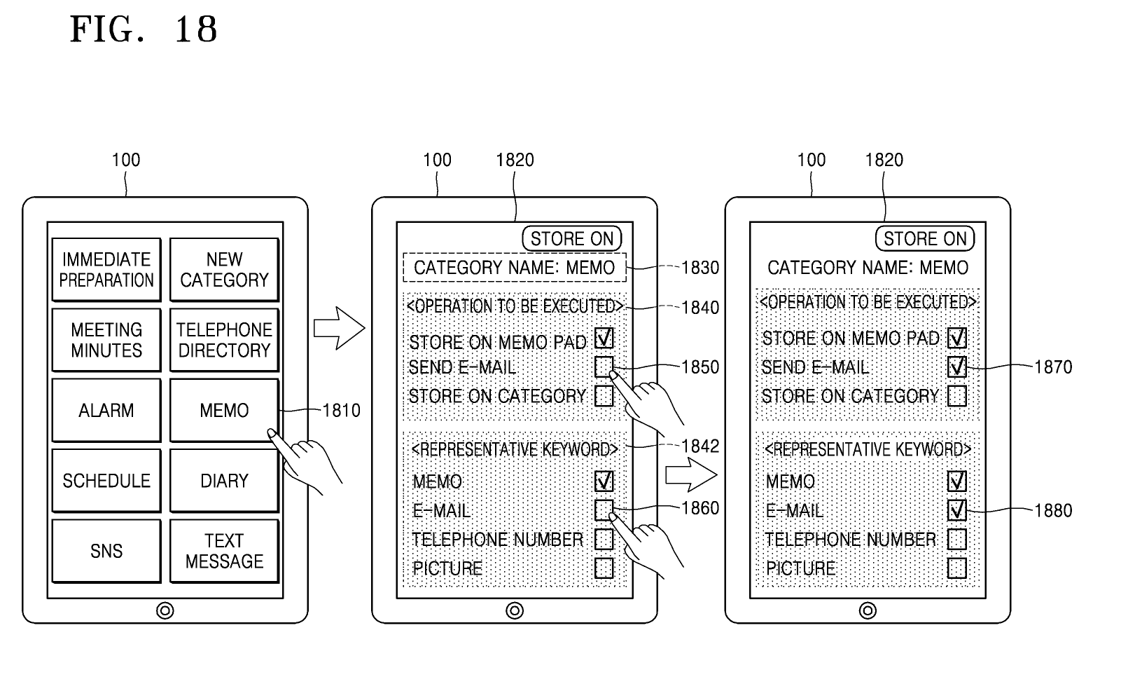

In FIG. 18, the electronic apparatus 100 displays a screen for changing category set-up 1820 for a category of memo 1810, after receiving the external input. The external input may include maintaining a touch input for longer than a specific period. The screen 1820 may allow for changing a name of a category, a representative keyword of a category, and an operation to execute. The electronic apparatus 100 displays, on a changing category set-up screen 1820, a category name set-up menu 1830, a category-related operation set-up menu 1840 and a category-related representative keyword set-up menu 1842. On the category-related operation set-up menu 1840, the external input may be received, and an operation to be executed may be changed 1850, based on the received external input. For the category-related representative keyword set-up menu 1842, the representative keyword may be changed 1860, based on the external input, after receiving the external input. By changing the category-related operation set-up, based on the received external input, a sending e-mail 1870 is added, and an e-mail 1880 is added to the category-related representative keyword.

According to an exemplary embodiment, examples may be prepared in programs executable on a computer and may be realized on a general-purpose, digital computer which executes programs using a computer-readable recording medium. The computer-readable medium may be an arbitrary, usable medium and include all of volatile as well as non-volatile media, separable as well in-separable type media. Also, the computer-readable medium may include all of computer storage media and communication media. The computer storage media include all of volatile as well as nonvolatile media and separable as well as in-separable media that are realized by arbitrary methods or technology for storing information such as computer-readable commands, data structure, program modules and other data. Communication media typically include computer-readable commands, data structure, program modules, other modulated data signal data such as a carrier wave, and other transmission mechanism as well as arbitrary information transmission media.

Exemplary embodiments are presented as central points. It should be understood that the exemplary embodiments described therein should be considered in a descriptive sense only and not for purposes of limitation. Descriptions of features or aspects within each embodiment should typically be considered as available for other similar features or aspects in other embodiments.

While exemplary embodiments have been described with reference to the figures, it will be understood by those of ordinary skill in the art that various changes in form and details may be made therein without departing from the spirit and scope as defined by the following claims.

It should be understood that the exemplary embodiments described therein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

What is claimed is:

1. A method of managing content by using an electronic apparatus, comprising:
obtaining content; and
executing an operation corresponding to a category related to the obtained content.

2. The method of managing content of claim 1, wherein the obtaining of the content further comprises:
receiving an external input; and
determining the category corresponding to the content, based on the external input.

3. The method of managing content of claim 1, wherein the executing of the operation further comprises:
searching for at least one selected from a character and an image in the obtained content;
identifying at least one selected from the character and the image; and
determining the category, based on the identification.

4. The method of managing content of claim 1, wherein the executing of the operation related to the category comprises:
if an available operation corresponding to the category is equal to at least two or more operations,
receiving an external input; and
executing at least one operation out of the available operations to the category, according to the external input.

5. The method of managing content of claim 1, wherein the obtaining the content comprises receiving signals from an input device corresponding to the executed application.

6. The method of managing content of claim 1, wherein the obtaining the content comprises receiving the location information of the electronic apparatus when obtaining the content.

7. The method of managing content of claim 1, wherein the operation corresponding to a category is one of a storing operation, a transmission operation, or a classification operation of the obtained content.

8. The method of managing content of claim 1, wherein the obtaining the content comprises generating a new category corresponding to the content.

9. An apparatus for managing content, the apparatus comprising:
an inputter configured to obtain content; and
a controller configured to control an execution of an operation corresponding to a category related to the obtained content.

10. The apparatus for managing content of claim 9, wherein the controller is configured to determine the category related to the content, based on an input received by the inputter.

11. The apparatus for managing content of claim 9, wherein the controller is configured to search for at least one selected from a character and an image in the obtained content, identify at least one selected from the character and the image, and to determine the category based on the identification.

12. The apparatus for managing content of claim 9, wherein, when two or more operations are related to the category, the controller is configured to execute at least one operation out of the two or more operations based on an input received by the inputter.

13. The apparatus for managing content of claim 9, wherein the inputter is configured to receive a signal from an input apparatus coupled with an application of the electronic apparatus.

14. The apparatus for managing content of claim 9, wherein the inputter is configured to receive location information of the electronic apparatus when obtaining the content.

15. The apparatus for managing content of claim 9, wherein the controller is configured to automatically execute the operation, which is one of a storing operation, a transmission operation, or a classification operation of the obtained content.

16. The apparatus for managing content of claim 9, wherein the controller is configured to generate a category corresponding to the obtained content.

17. A non-transitory computer-readable recording medium storing a program comprising instructions, which when executed by a computer, performs the method of claim 1.
